(19) United States
(12) Patent Application Publication
(10) Pub. No.: US 2018/0352405 A1
(43) Pub. Date: Dec. 6, 2018

(54) WIRELESS COMMUNICATION TERMINAL, INFORMATION PROCESSING METHOD AND STORAGE MEDIUM

(71) Applicant: NEC Corporation, Minato-ku, Tokyo (JP)

(72) Inventor: Norihito FUJITA, Tokyo (JP)

(73) Assignee: NEC Corporation, Minato-ku, Tokyo (JP)

(21) Appl. No.: 15/527,822

(22) PCT Filed: Jul. 17, 2015
(86) PCT No.: PCT/JP2015/003619

§ 371 Date: May 18, 2017

(30) Foreign Application Priority Data
Nov. 28, 2014 (JP) 2014-241947

(51) Int. Cl. H04W 4/80; H04W 4/02

(52) U.S. Cl. CPC H04W 4/80; H04W 40/20; H04W 4/023

(57) ABSTRACT

A wireless communication terminal of the present invention includes: a short-range wireless communication unit; a data storage unit; a data transmission/reception unit that transmits and receives data stored in the data storage unit to and from another wireless communication terminal by means of short-range wireless communication; and a terminal specifying information storage unit that stores transmission-direction-side terminal specifying information that is information specifying a transmission-direction-side wireless communication terminal being another wireless communication terminal located adjacent to an own terminal in a data transmission direction on a path established to transmit data from the own terminal via another wireless communication terminal by means of short-range wireless communication, wherein the data transmission/reception unit transmits data stored in the data storage unit of the own terminal by means of short-range wireless communication to only the transmission-direction-side wireless communication terminal specified in the transmission-direction-side terminal specifying information among other wireless communication terminals within a range of short-range wireless communication, and receives and stores data transmitted by means of short-range wireless communication from another wireless communication terminal in the data storage unit.

### TECHNICAL FIELD

The present invention relates to a mobile wireless communication terminal.

### BACKGROUND ART

In recent years, mobile wireless communication terminals have been used in every situation with development of a wireless communication technology. The wireless communication terminals may be required to perform highly reliable data transfer even in a mobile environment where mutual intermittent network connection is impossible. As such a network control method, a Delay/Disruption-Tolerant Network (DTN) is known. The DTN is a method of relaying and transmitting data to other communication terminals while accumulating data to be transferred in each communication terminal.

The DTN includes epidemic routing, as one data transfer method, which is disclosed in, for example, PTL 1. The epidemic routing is a data transfer method in which a communication terminal, connected with another terminal by means of wireless communication, propagates data, while complementing difference data based on information about data held by each terminal.

Herein, a specific example of a data transfer method of the epidemic routing will be described with reference to FIG. 1. FIG. 1(A) illustrates a Pull-type data transfer method of the epidemic routing.

First, wireless communication terminals_A and B are connected with each other by being located within a range of short-range wireless communication. Then, the wireless communication terminals_A and B exchange a message (hereinafter, a Summary Vector Message (SVM)) including a Summary Vector that is a list of contents (held information) being data stored in the own terminal (Step S1). Accordingly, each of the terminals_A and B can grasp data that the own terminal does not hold yet the counter terminal holds. Then, in the example of FIG. 1(A), the terminal_B requests, based on the SVM, the terminal_A for data that the terminal_A holds yet the own terminal_B does not hold (Step S2). In response to this request, the terminal_A transmits contents being the data that the own terminal_A holds to the terminal_B (Step S3). Accordingly, the terminal_B can hold the data that the terminal_A holds, and can synchronize data mutually with the terminal_A.

In addition, FIG. 1(B) illustrates a Push-type data transfer method of the epidemic routing. First, terminals_A and B are connected with each other by being located within a range of short-range wireless communication. Then, the terminals_A and B exchange an SVM similarly as described above (Step S11). At this time, it is assumed that there are data that the terminal_A holds yet the terminal_B does not hold. Then, the terminal_A transmits, based on the SVM, data that the terminal_B does not hold to the terminal_B (Step S12). In other words, in the Push type, the terminal_A transmits data to the terminal_B even without a request from the terminal_B, unlike the above-described Pull type. Accordingly, the terminal_B can hold the data that the terminal_A holds, and can synchronize data mutually with the terminal_A.

Then, the epidemic routing described above is preferably used in an ad-hoc mode as a wireless network setting under an environment where wireless communication terminals are freely movable. This is because wireless communication terminals in the ad-hoc mode are capable of forming a peer-to-peer link by using short-range wireless communication even without existence of an access point. In addition, wireless communication terminals in the ad-hoc mode need no association establishment and perform fast session establishment.

In this manner, use of the epidemic routing in the ad-hoc mode allows to relay and transmit data within moving wireless communication terminals by means of short-range wireless communication while accumulating the data in the wireless communication terminals. It also becomes possible to transmit data to a distant terminal. For example, as illustrated in FIG. 2, even in a situation where there are wireless communication terminals such as movable portable telephone terminals_A1 to A6, it is possible to transmit data to another neighboring wireless communication terminal by means of short-range wireless communication, as illustrated with arrows in FIG. 2. For example, even if it is impossible, between the terminal_A1 and the terminal_A6, to directly communicate with each other by means of short-range wireless communication, it becomes possible to synchronize data eventually after relay transmission via the other terminals_A2 to A4.

### CITATION LIST

### Patent Literature

PTL 1: International Publication WO 2014/061314

### SUMMARY OF INVENTION

### Technical Problem

However, the data transmission method using the epidemic routing in the ad-hoc mode as described above has a problem as follows. First, under the above-described environment, since data are transmitted to all wireless communication terminals being involved, all pieces of data stored in a large number of respective terminals are to be transmitted. As a result, a large volume of data may be transmitted in a network. This increases an amount of traffic in the network and causes a problem of reduction in data transmission efficiency.

In addition, there is also a case in which a wireless communication terminal not requiring data transmission may be present. In this case, wasteful wireless communication is generated and this causes a problem of reduction in data transmission efficiency similarly to the above.

Then, not only the data transmission method using the epidemic routing, but also a case in which a wireless communication terminal transmits and propagates data to other terminals within a range of short-range wireless communication, may cause the above-described problem.

In view of the above, an object of the present invention is to provide a wireless communication terminal capable of solving a problem of reduction in data transmission efficiency, which is the above-described problem.

### Solution to Problem

An example of the present invention is a wireless communication terminal, the terminal includes:

a short-range wireless communication unit that performs short-range wireless communication mutually with another wireless communication terminal within a range of short-range wireless communication;

a data storage unit that stores specific data;

a data transmission/reception unit that transmits and receives data stored in the data storage unit to and from another wireless communication terminal by means of short-range wireless communication; and

a terminal specifying information storage unit that stores transmission-direction-side terminal specifying information that is information specifying a transmission-direction-side wireless communication terminal being another wireless communication terminal located adjacent to an own terminal in a data transmission direction on a path established to transmit data from the own terminal via another wireless communication terminal by means of short-range wireless communication, wherein

the data transmission/reception unit transmits data stored in the data storage unit of the own terminal by means of short-range wireless communication to only the transmission-direction-side wireless communication terminal specified in the transmission-direction-side terminal specifying information among other wireless communication terminals within a range of short-range wireless communication, and receives and stores data transmitted by means of short-range wireless communication from another wireless communication terminal in the data storage unit.

An example of the present invention is a program for causing a control device of a wireless communication terminal. The terminal includes a short-range wireless communication unit that performs short-range wireless communication mutually with another wireless communication terminal within a range of short-range wireless communication, and a data storage unit that stores specific data. The program is to implement:

a data transmission/reception unit that transmits and receives data stored in the data storage unit to and from another wireless communication terminal by means of short-range wireless communication; and

a terminal specifying information storage unit that stores transmission-direction-side terminal specifying information that is information specifying a transmission-direction-side wireless communication terminal being another wireless communication terminal located adjacent to an own terminal in a data transmission direction on a path established to transmit data from the own terminal via another wireless communication terminal by means of short-range wireless communication, and further implement that

the data transmission/reception unit transmits data stored in the data storage unit of the own terminal by means of short-range wireless communication to only the transmission-direction-side wireless communication terminal specified in the transmission-direction-side terminal specifying information among other wireless communication terminals within a range of short-range wireless communication, and receives and stores data transmitted by means of short-range wireless communication from another wireless communication terminal, in the data storage unit.

An example of the present invention is an information processing method for a wireless communication terminal including a short-range wireless communication unit that performs short-range wireless communication mutually with another wireless communication terminal within a range of short-range wireless communication, and a data storage unit that stores specific data. In the information processing method, the wireless communication terminal stores transmission-direction-side terminal specifying information that is information specifying a transmission-direction-side wireless communication terminal being another wireless communication terminal located adjacent to an own terminal in a data transmission direction on a path established to transmit data from the own terminal via another wireless communication terminal by means of short-range wireless communication,

In the method, the wireless communication terminal is configured to transmit and receive data stored in the data storage unit to and from another wireless communication terminal by means of short-range wireless communication, and

further, the wireless communication terminal transmits data stored in the data storage unit of the own terminal by means of short-range wireless communication to only the transmission-direction-side wireless communication terminal specified in the transmission-direction-side terminal specifying information among other wireless communication terminals within a range of short-range wireless communication.

### Advantageous Effects of Invention

The present invention is capable of improving data transmission efficiency of a wireless communication terminal by being configured as described above.

### BRIEF DESCRIPTION OF DRAWINGS

FIG. 1 is a diagram for describing a data transmission method using an epidemic routing;

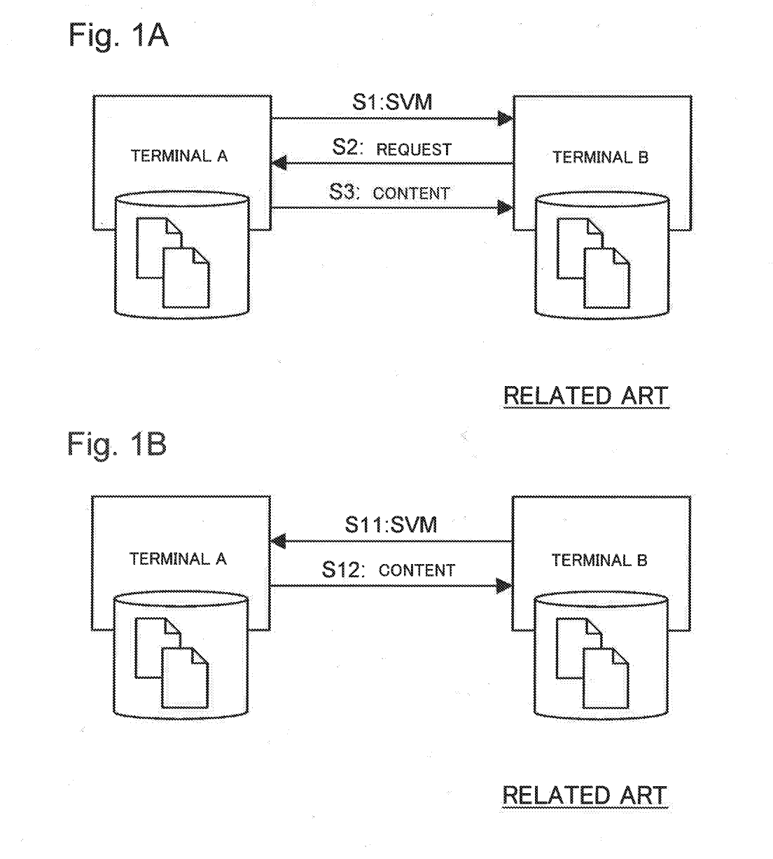

FIG. 2 is a diagram illustrating a way of data transmission using the epidemic routing;

FIG. 3 is a functional block diagram illustrating a configuration of a wireless communication terminal according to an example embodiment 1 of the present invention;

FIG. 4 is a diagram illustrating a way of establishing a data transmission path performed by the wireless communication terminal disclosed in FIG. 3;

FIG. 5 is a diagram illustrating a way of establishing a data transmission path performed by the wireless communication terminal disclosed in FIG. 3;

FIG. 6 is a diagram illustrating a way of establishing a data transmission path performed by the wireless communication terminal disclosed in FIG. 3;

FIG. 7 is a flowchart illustrating an operation at a time of establishing a data transmission path of the wireless communication terminal disclosed in FIG. 3;

FIG. 8 is a sequence diagram illustrating an operation at a time of establishing a data transmission path among the wireless communication terminals disclosed in FIG. 3;

FIG. 9 is a diagram illustrating a way of data transmission performed by the wireless communication terminal disclosed in FIG. 3;

FIG. 10 is a flowchart illustrating an operation at a time of data transmission of the wireless communication terminal disclosed in FIG. 3;

FIG. 11 is a sequence diagram illustrating an operation at a time of data transmission among the wireless communication terminals disclosed in FIG. 3;

FIG. 12 is a functional block diagram illustrating a configuration of a wireless communication terminal according to an example embodiment 2 of the present invention;

FIG. 13 is a functional block diagram illustrating a configuration of a wireless communication terminal according to an example embodiment 3 of the present invention;

FIG. 14 is a diagram illustrating a configuration of a wireless communication system according to an example embodiment 4 of the present invention; and

FIG. 15 is a functional block diagram illustrating a configuration of a wireless communication terminal according to Supplementary note 1 of the present invention.

### DESCRIPTION OF EMBODIMENTS

### Example Embodiment 1

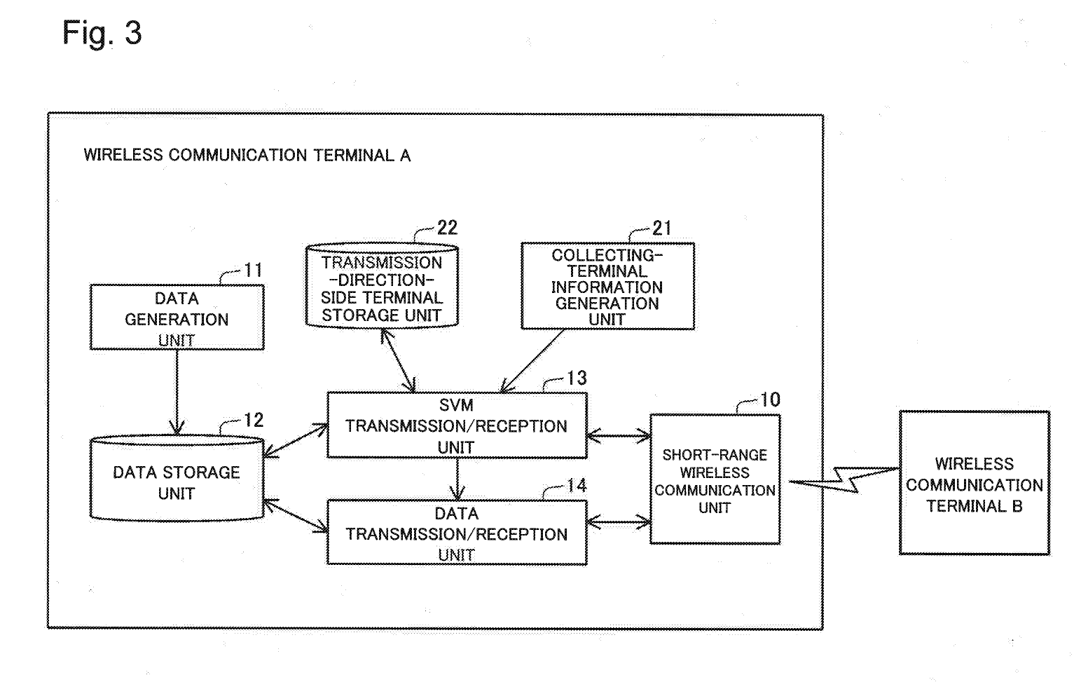

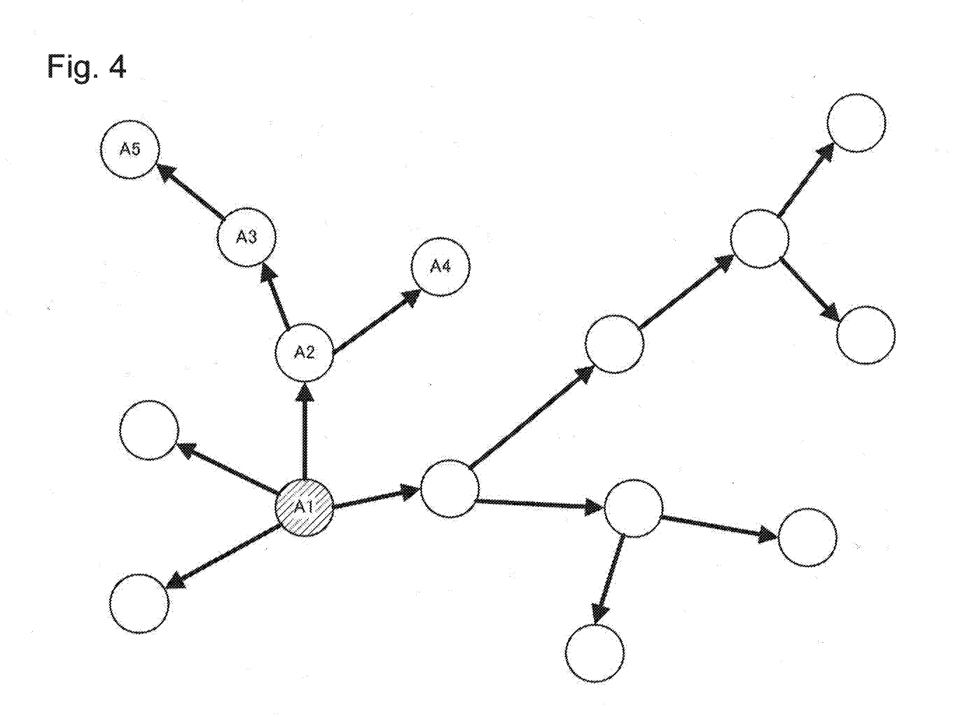

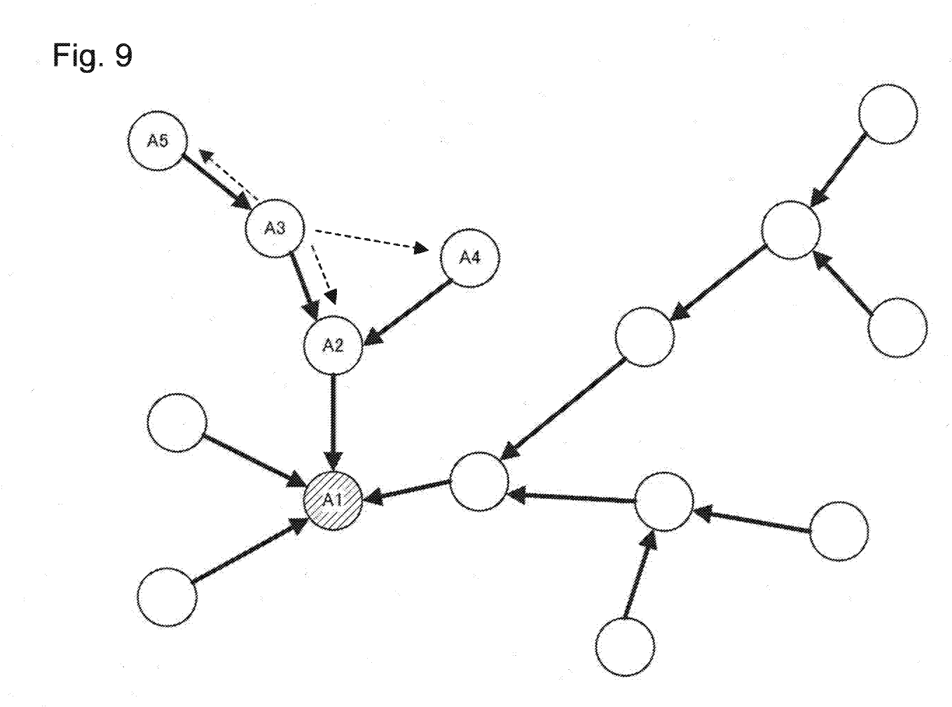

A first example embodiment of the present invention will be described with reference to FIGS. 3 through 11. FIG. 3 is a block diagram illustrating a configuration of a wireless communication terminal. FIGS. 4 through 8 are diagrams for describing a way of establishing a data transmission path performed by the wireless communication terminal. FIGS. 9 through 11 are diagrams for describing a way of data transmission performed by the wireless communication terminal.

A wireless communication terminal_A according to the present example embodiment is a mobile information processing device such as a portable telephone terminal. Then, other wireless communication terminals also have the same configuration. Note that the wireless communication terminal_A according to the present invention is not limited to be a portable telephone terminal, but may be any information processing device. In addition, the wireless communication terminal_A may be an information processing device that is used alone, or may be an information processing device that is used in conjunction with another device or by being incorporated in another device.

[Configuration]

As illustrated in FIG. 3, first, the wireless communication terminal_A according to the present example embodiment includes a short-range wireless communication unit 10. The short-range wireless communication unit 10 performs short-range wireless communication mutually with other wireless communication terminals within a range of short-range wireless communication. Herein, the short-range wireless communication to be implemented by the short-range wireless communication unit 10 is different from wireless communication performed with a portable base station. The short-range wireless communication is wireless communication performed between wireless communication terminals in accordance with a wireless communication standard such as Wireless Fidelity (Wi-Fi) and Bluetooth (registered trademark). Note that the short-range wireless communication may be performed in accordance with any standard.

In addition, the wireless communication terminal_A includes an arithmetic operation device such as a Central Processing Unit (CPU), and a storage device such as a Solid State Drive (SSD). Then, as illustrated in FIG. 3, the wireless communication terminal_A includes a data generation unit 11, an SVM transmission/reception unit 13, a data transmission/reception unit 14, and a collecting-terminal information generation unit 21. The above units are constructed by incorporating a program in the arithmetic operation device. In addition, the wireless communication terminal_A includes a data storage unit 12 and a transmission-direction-side terminal storage unit 22 that are formed in the storage device.

The data generation unit 11 generates data based on a status of the wireless communication terminal_A and data based on information input to the terminal_A, and stores the generated data in the data storage unit 12. For example, the data to be generated by the data generation unit 11 are movement history based on positional information acquired by a Global Positioning System (GPS) equipped in the wireless communication terminal_A. The data to be generated by the data generation unit 11 are also data measured by a predetermined sensor connected with the terminal_A. Further, the data to be generated by the data generation unit 11 are information representing an operation status of a device equipped with the terminal_A. Then, the data generated by the data generation unit 11 are stored in the data storage unit 12 in a distinctive manner as one piece of content data on a predetermined unit basis, for example, on a day-of-generation basis.

The SVM transmission/reception unit 13 and the data transmission/reception unit 14 cooperate to function as a data transmission/reception unit. The data transmission/reception unit transmits and receives data to and from another wireless communication terminal_B by using the epidemic routing described above. Note that a configuration of the SVM transmission/reception unit 13 when functioning as the data transmission/reception unit will be described later. When performing the epidemic routing, the SVM transmission/reception unit 13 transmits a message to other wireless communication terminals within a range of short-range wireless communication. The message (hereinafter, a Summary Vector Message (SVM)) includes a Summary Vector that is a list of data stored in the data storage unit 12.

In addition, independently of data transmission and reception, the SVM transmission/reception unit 13 functions as a propagation information transmission/reception unit (terminal specifying information processing unit). The propagation information transmission/reception unit transmits and receives propagation information, which will be described later, as an SVM to and from other wireless communication devices within a range of short-range wireless communication by using the epidemic routing. Note that the transmission and reception of propagation information may not be necessarily performed by using the epidemic routing, but may be performed by using another method.

Herein, a case in which the SVM transmission/reception unit 13 functions as the propagation information transmission/reception unit will be described. First, it is assumed that the wireless communication terminal_A is set as a “collecting terminal” that collects pieces of data respectively held by wireless communication terminals. In this case, the collecting-terminal information generation unit 21 generates collecting terminal information that is information representing that the wireless communication terminal_A is a collecting terminal. The collecting-terminal information generation unit 21 then generates sending opportunity information (for example, time, version information, or a sequence number) specifying an opportunity to send propagation information. The collecting-terminal information generation unit 21 passes the sending opportunity information along with the collecting terminal information to the SVM transmission/reception unit 13. Then, the SVM transmission/reception unit 13 transmits an SVM including the collecting terminal information and the sending opportunity information as propagation information to other wireless communication terminals located within a range of short-range wireless communication.

For example, it is assumed that a wireless communication terminal illustrated with a sign A1 (see a shaded portion) in FIG. 4 is set as a collecting terminal. In this case, the SVM transmission/reception unit 13 equipped in the wireless communication terminal_A1 transmits, as illustrated with arrows in FIG. 4, an SVM including collecting terminal information to other wireless communication terminals (A2 and the like) located within a range of short-range wireless communication. Note that every time the SVM transmission/reception unit 13 sends an SVM, the collecting-terminal information generation unit 21 newly generates the sending opportunity information. The sending opportunity information is included along with collecting terminal information in an SVM as propagation information. However, the SVM as propagation information may not necessarily include collecting terminal information and sending opportunity information, but may be information that is understood as being propagation information.

In addition, when the SVM transmission/reception unit 13 receives an SVM from another wireless communication terminal and the SVM includes collecting terminal information, the SVM is treated as propagation information. Then, the SVM transmission/reception unit 13 specifies the other wireless communication terminal having transmitted the SVM, which is the received propagation information, as being a transmission-direction-side terminal (transmission-direction-side wireless communication terminal). The transmission-direction-side terminal is a terminal located adjacent to the own terminal in a data transmission direction on a data transmission path, which will be described later.

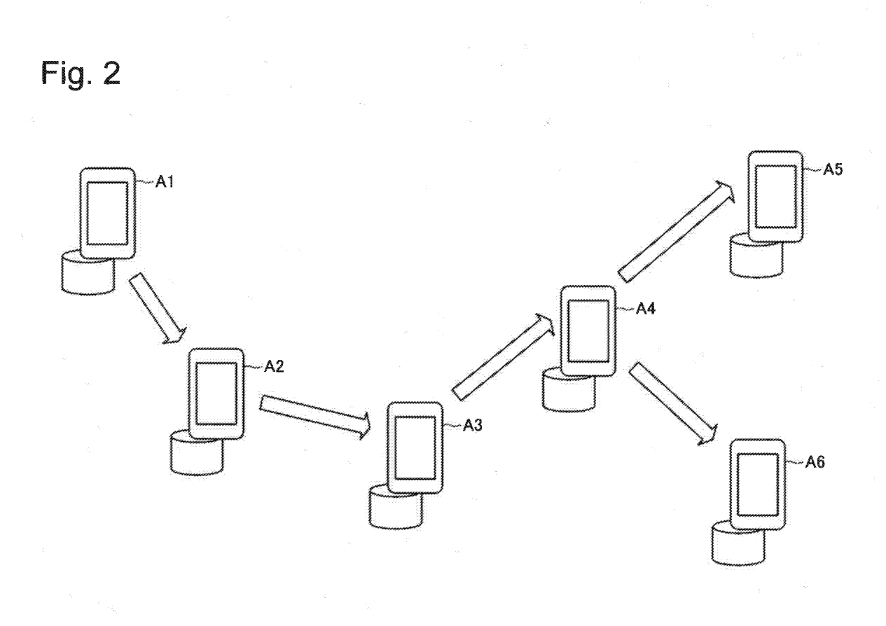

The SVM transmission/reception unit 13 then stores transmission-direction-side terminal information (transmission-direction-side terminal specifying information) in the transmission-direction-side terminal storage unit 22. The transmission-direction-side terminal information is information specifying a transmission-direction-side terminal. For example, the SVM transmission/reception unit 13 stores terminal identification information as transmission-direction-side terminal information in the transmission-direction-side terminal storage unit 22 (terminal specifying information storage unit). The terminal identification information is information assigned to another wireless communication terminal in advance, and the information is included in an SVM that is propagation information transmitted from the another wireless communication terminal. As one example, it is assumed that the wireless communication terminal illustrated with the sign A2 in FIG. 2 receives propagation information from the wireless communication terminal with the sign A1. In this case, the SVM transmission/reception unit 13 stores identification information (herein, “A1”) of the wireless communication terminal_A1 as transmission-direction-side terminal information.

In addition, the SVM transmission/reception unit 13 receives an SVM as propagation information as described above. Thereafter, the SVM transmission/reception unit 13 further transmits the propagation information as an SVM to other wireless communication terminals within a range of short-range wireless communication. At this time, the SVM transmission/reception unit 13 transmits identification information of the own terminal being a transmission source in a manner to be included in an SVM that is the propagation information.

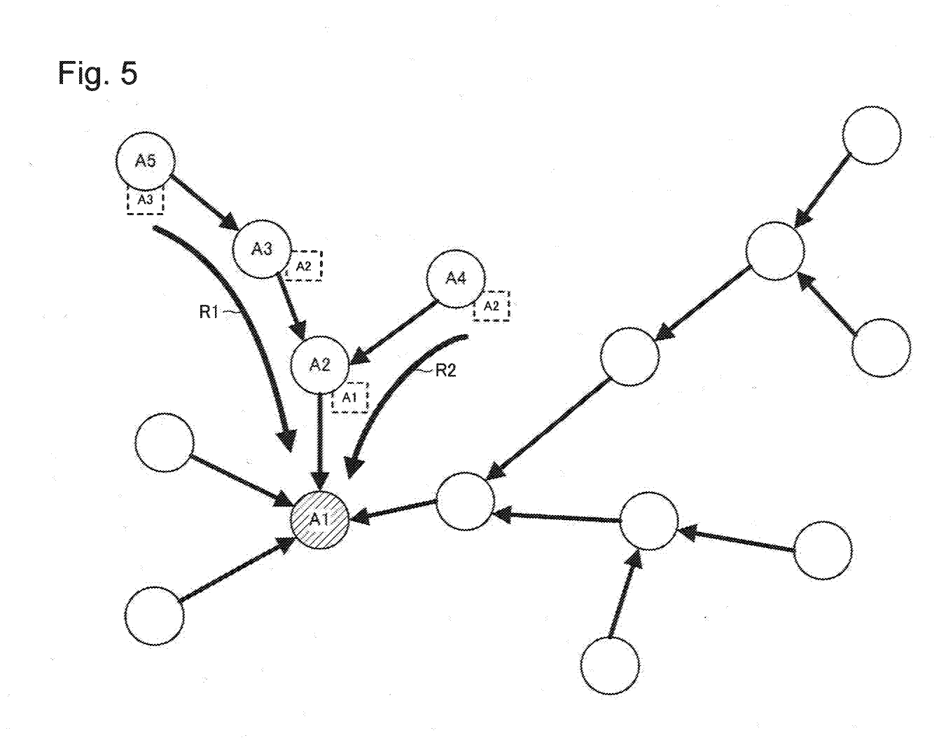

As described above, an SVM as propagation information is transmitted and received by the SVM transmission/reception unit 13. Accordingly, each of the wireless communication terminals stores another wireless communication terminal being a transmission source from which the SVM is directly received, as a transmission-direction-side terminal. For example, as illustrated in FIG. 4, it is assumed that propagation information is propagated in order of terminals A1-A2-A3-A5. In this case, as illustrated with dotted lines in FIG. 5, the terminal_A2 stores A1, the terminal_A3 stores A2, and the terminal_A5 stores A3 as transmission-direction-side terminals, respectively. Then, by the wireless communication terminals respectively storing the transmission-direction-side terminals, a path formed by tracing the transmission-direction-side terminals is established as a data transmission path. The path is, in other words, a path that is reverse to a path through which the propagation information is propagated from the collecting terminal_A1. For example, in the example of FIG. 5, a path of the terminals A5-A3-A2-A1 and a data transmission path of the terminals A4-A2-A1 are established, as illustrated with arrows R1 and R2. Note that a direction from each wireless communication terminal toward a collecting terminal is a data transmission direction.

Herein, it is assumed that the SVM transmission/reception unit 13 receives an SVM as new propagation information while transmission-direction-side terminal information is already stored in the transmission-direction-side terminal storage unit 22 of the own terminal. In this case, the SVM transmission/reception unit 13 operates as follows. First, an SVM as propagation information includes collecting terminal information. Thus, upon reception of an SVM, the SVM transmission/reception unit 13 also stores collecting terminal information along with transmission-direction-side terminal information in association with each other in the transmission-direction-side terminal storage unit 22. The collecting terminal information is information on a propagation source of the SVM, and the transmission-direction-side terminal information is information on a transmission source of the SVM. Then, it is assumed that the SVM transmission/reception unit 13 newly receives an SVM that includes new collecting terminal information being different from the collecting terminal information associated with the already stored transmission-direction-side terminal information. In this case, the SVM transmission/reception unit 13 also stores information on a wireless communication terminal being a transmission source of the new SVM additionally as new transmission-direction-side terminal information in association with the new collecting terminal information. In other words, the SVM transmission/reception unit 13 stores, for each collecting terminal sending propagation information, transmission-direction-side terminal information of a transmission-direction-side terminal at a time of propagation of the propagation information.

In addition, an SVM as propagation information includes sending opportunity information described above along with collecting terminal information. Thus, upon reception of an SVM, the SVM transmission/reception unit 13 also stores sending opportunity information along with transmission-direction-side terminal information in association with each other. Then, it is assumed that the SVM transmission/reception unit 13 receives an SVM as new propagation information propagated from a collecting terminal being the same as a collecting terminal associated with the already stored transmission-direction-side terminal information. In this case, the SVM transmission/reception unit 13 compares the stored sending opportunity information with sending opportunity information included in the received SVM. When a result of the comparison shows that both pieces of the sending opportunity information are the same, the already stored transmission-direction-side terminal information is left as is in the transmission-direction-side terminal storage unit 22. Whereas, a wireless communication terminal being a transmission source of the newly received SVM is not determined as being a transmission-direction-side terminal and information thereof is not stored.

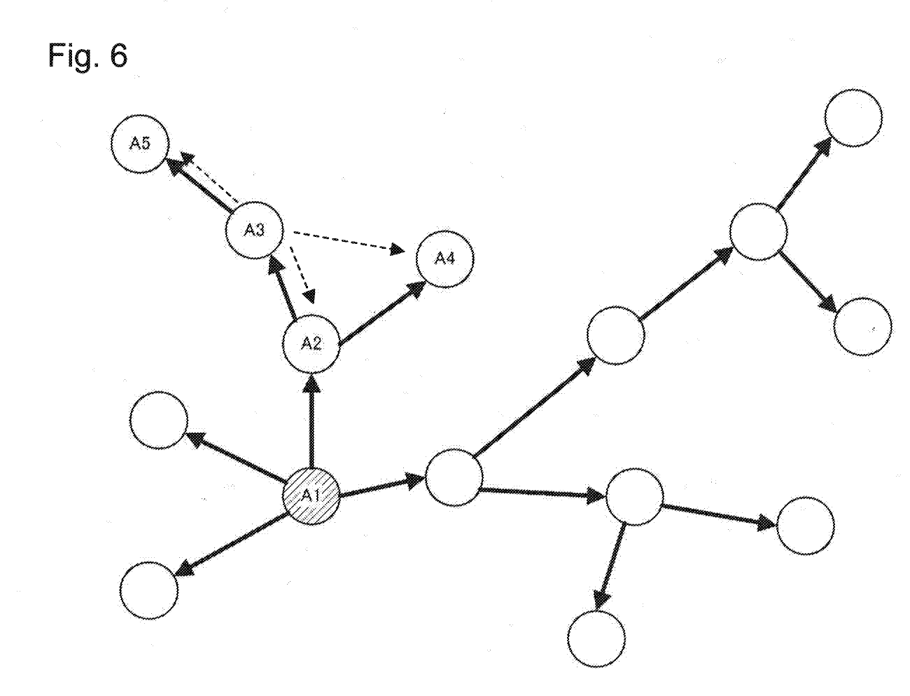

An example at a time of the above-described reception of an SVM will be described with reference to FIGS. 5 and 6. First, in the example of FIG. 5, an SVM as propagation information is propagated from the wireless communication terminal_A2 to the other wireless communication terminals_A3 and A4. The wireless communication terminals_A3 and A4 respectively store the wireless communication terminal_A2 as a transmission-direction-side terminal. In this condition, it is assumed that the wireless communication terminal_A3 subsequently transmits an SVM as propagation information within a range of short-range wireless communication, and then the wireless communication terminals_A2, A4, and A5 receive the SVM, as illustrated with dotted arrows. At this time, the wireless communication terminals_A2 and A4 have already received propagation information sent at the same sending opportunity from the same collecting terminal, and have stored transmission-direction-side terminal information at the time. In this case, the wireless communication terminals_A2 and A4 do not store new transmission-direction-side terminal information based on the new propagation information.

On the other hand, it is assumed that the SVM transmission/reception unit 13 receives an SVM as propagation information newly sent and propagated from a collecting terminal that has sent propagation information at a time of storage of already stored transmission-direction-side terminal information. In this case, the SVM transmission/reception unit 13 updates and stores the transmission-direction-side terminal information. Specifically, it is assumed that the SVM transmission/reception unit 13 receives an SVM as new propagation information propagated from a collecting terminal being the same as a collecting terminal associated with already stored transmission-direction-side terminal information. In this case, the SVM transmission/reception unit 13 compares stored sending opportunity information with sending opportunity information included in the received SVM. As a result of the comparison, it is assumed that the sending opportunity information included in the newly received SVM indicates an opportunity temporally later than that of the already stored sending opportunity information. In this case, a wireless communication terminal being a transmission source of the newly received SVM is determined as being a new transmission-direction-side terminal. Then, the already stored information is replaced by updating with and storing transmission-direction-side terminal information of the new transmission-direction-side terminal.

Next, a case in which the SVM transmission/reception unit 13 and the data transmission/reception unit 14 cooperate to function as a data transmission/reception unit will be described. With generation of data to be stored in the data storage unit 12 as a trigger, the SVM transmission/reception unit 13 transmits an SVM within a range of short-range wireless communication via the short-range wireless communication unit 10. The SVM is a message including a Summary Vector that is a list of data stored in the data storage unit 12. In addition, the SVM transmission/reception unit 13 receives an SVM transmitted from another wireless communication terminal_B located within the range of short-range wireless communication. In other words, the SVM transmission/reception unit 13 performs short-range wireless communication mutually with the other wireless communication terminal_B located within the range of short-range wireless communication, and performs SVM exchange. The SVM transmission/reception unit 13 then notifies the data transmission/reception unit 14 of exchanged SVMs and a status of SVM transmission and reception. Note that the SVM transmission/reception unit 13 may start the above-described SVM exchange periodically, at set timing, or at arbitrary timing.

Note that the SVM transmission/reception unit 13 performs SVM exchange at any timing continually thereafter. For example, SVM exchange is performed with other wireless communication terminals by means of short-range wireless communication when data transmission and reception is performed by the data transmission/reception unit 14 or when data in the data storage unit 12 are updated. Further, SVM exchange is performed at a fixed interval during an activated state.

The data transmission/reception unit 14 determines whether transmission and reception of data stored in the data storage unit 12 is to be performed or not based on a result of the above-described SVM exchange performed by the SVM transmission/reception unit 13. In other words, the data transmission/reception unit 14 determines by comparing an SVM of the own terminal_A with an SVM from the other wireless communication terminal_B. At this time, the data transmission/reception unit 14 transmits data stored in the data storage unit 12 of the own terminal_A to only the wireless communication terminal_B by means of short-range wireless communication. Among other wireless communication terminals within a range of short-range wireless communication, the wireless communication terminal_B is related to transmission-direction-side terminal information stored in the transmission-direction-side terminal storage unit 22 of the own terminal_A.

For example, the data transmission/reception unit 14 transmits data that the own terminal_A holds yet the other terminal_B does not hold to the other terminal_B. At this time, the data transmission/reception unit 14 of the terminal_A transmits data to the other terminal_B by using the Push type of the epidemic routing without requiring a data acquisition request from the terminal_B. However, the data transmission/reception unit 14 may transmit data after receiving a data acquisition request from the terminal_B.

In this manner, the data transmission/reception unit 14 transmits, as a result of SVM exchange, data stored in the own terminal_A to only the other wireless communication terminal_B stored as a transmission-direction-side terminal with respect to the own terminal_A. Therefore, the data transmission/reception unit 14 does not transmit data to other wireless communication terminals. For example, the data transmission/reception unit 14, having received a data request from another wireless communication terminal using the Pull type of the epidemic routing, does not transmit data unless the another terminal is stored as a transmission-direction-side terminal.

Note that, when a plurality of pieces of transmission-direction-side terminal information are stored in the transmission-direction-side terminal storage unit 22 of the own terminal_A, the data transmission/reception unit 14 transmits data to only a plurality of wireless communication terminals respectively related to the plurality of pieces of transmission-direction-side terminal information.

Herein, an example of data transmission will be described with reference to FIG. 9. First, it is assumed that a wireless communication terminal illustrated with a sign A3 performs data transmission by using the epidemic routing. In this case, first, the wireless communication terminal transmits an SVM to other wireless communication terminals_A2, A4, and A5 located within a range of short-range wireless communication, as illustrated with dotted arrows. Then, the wireless communication terminal_A3 performs SVM exchange with the other wireless communication terminals_A2, A4, and A5. However, the wireless communication terminal_A3 transmits, only to the wireless communication terminal_A2 that is a stored transmission-direction-side terminal, data that the terminal_A2 does not hold.

Note that the above-described SVM transmission/reception unit 13 may perform short-range wireless communication with only the wireless communication terminal_B at a time of SVM exchange with other wireless communication terminals located within a range of short-range wireless communication. The wireless communication terminal_B is related to transmission-direction-side terminal information stored in the transmission-direction-side terminal storage unit 22 of the own terminal_A. In this manner, the data transmission/reception unit 14 performs SVM exchange with only the transmission-direction-side terminal_B. Thereby, the data transmission/reception unit 14 is necessarily able to transmit, to only the transmission-direction-side terminal_B, data that are stored in the own terminal_A yet are not stored in the transmission-direction-side terminal_B.

As described above, the wireless communication terminal_A relays and transmits data to only a stored transmission-direction-side terminal. Accordingly, the data are collected in a transmission direction along an established data transmission path as described above, and the data are resultantly collected by the collecting terminal.

[Operation]

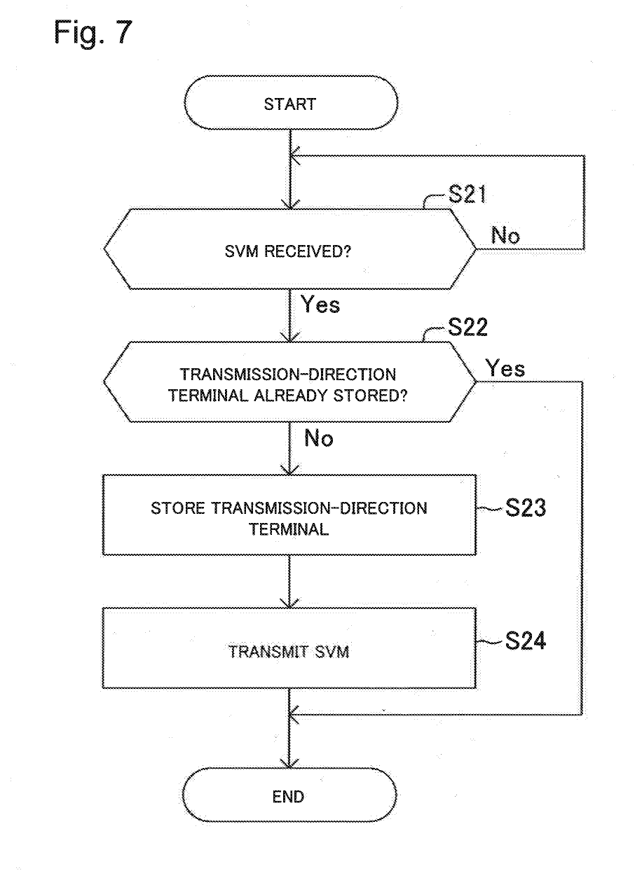

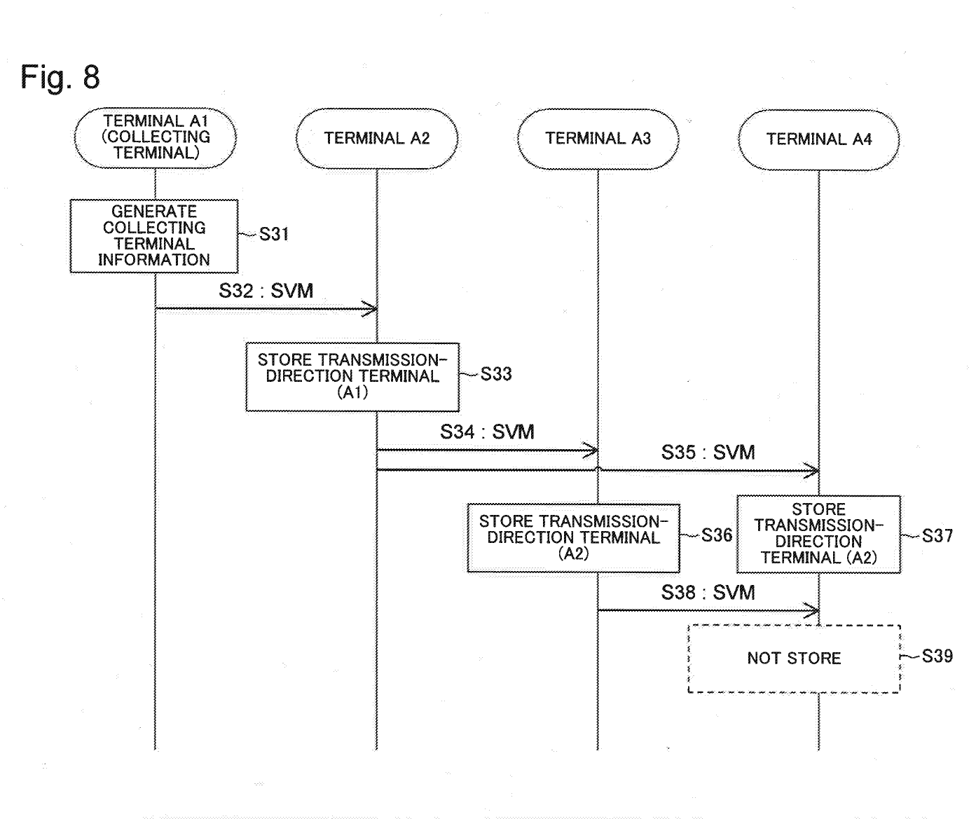

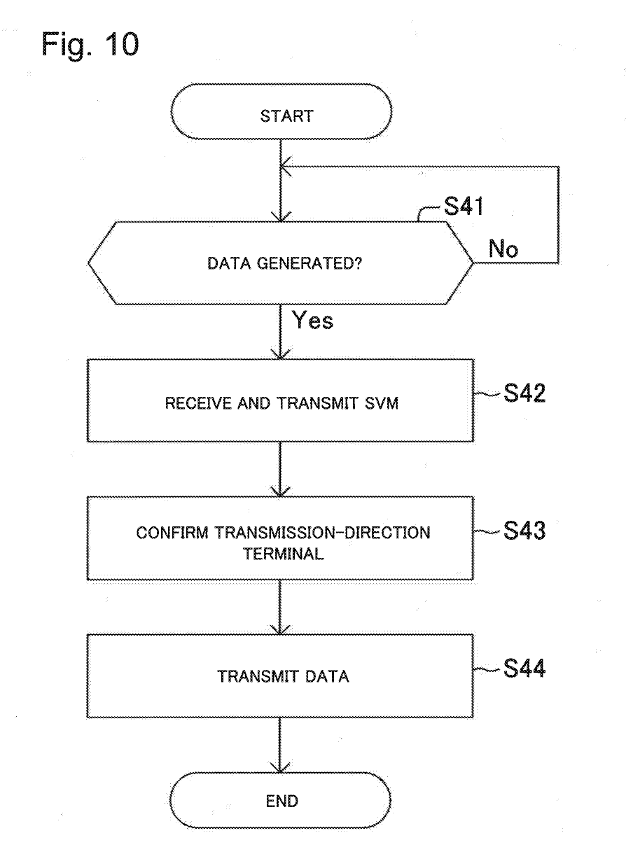

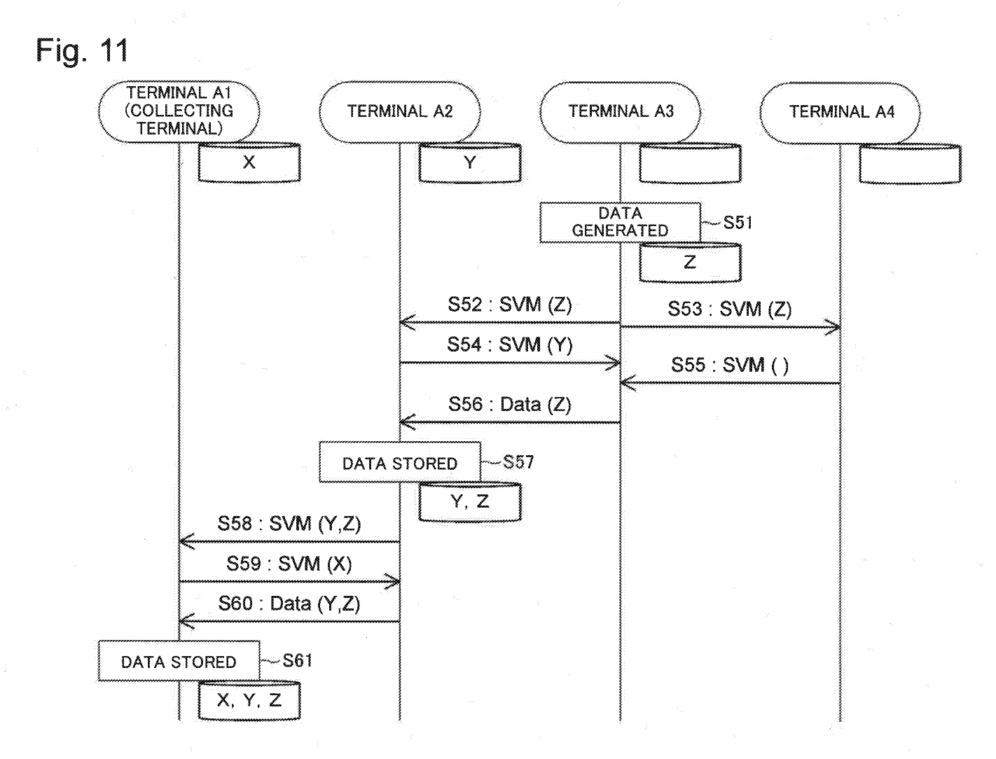

Next, an operation of the above-described wireless communication terminal will be described with reference to FIGS. 4 through 11. FIGS. 4 through 8 are diagrams for describing an operation at a time of establishing a data transmission path. Among the figures, FIG. 7 is a flowchart illustrating an operation of the wireless communication terminal alone, and FIG. 8 is a sequence diagram illustrating an operation among the wireless communication terminals. FIGS. 9 through 11 are diagrams for describing an operation at a time of data transmission. Among the figures, FIG. 10 is a flowchart illustrating an operation of the wireless communication terminal alone, and FIG. 11 is a sequence diagram illustrating an operation among the wireless communication terminals.

First, the operation at a time of establishing a data transmission path will be described. Note that, in this example, a case in which a collecting terminal_A1 among wireless communication terminals is set in advance, as illustrated with the shaded portion in FIG. 4, will be described as an example.

First, the collecting terminal_A1, which is a wireless communication terminal, generates collecting terminal information representing that the own terminal is a collecting terminal and sending opportunity information representing a sending opportunity (Step S31 in FIG. 8). The collecting terminal_A1 then transmits an SVM as propagation information including the generated collecting terminal information and the sending opportunity information within a range of short-range wireless communication (Step S32 in FIG. 8).

Then, as illustrated in FIG. 4, it is assumed that the wireless communication terminal_A2, which is located within the range of short-range wireless communication of the collecting terminal_A1, receives the SVM as the propagation information sent from the collecting terminal_A1 (Step S21 in FIG. 7: Yes). Then, the wireless communication terminal_A2 determines whether to newly store transmission-direction-side terminal information (Step S22 in FIG. 7). The determination is made based on information stored in the transmission-direction-side terminal storage unit 22 of the own terminal_A2 and the collecting terminal information and the sending opportunity information included in the received SVM.

At this time, when transmission-direction-side terminal information based on an SVM as propagation information sent and propagated at the same sending opportunity from the same collecting terminal_A1 is stored (Step S22 in FIG. 7: Yes), the wireless communication terminal_A2 does not newly store transmission-direction-side terminal information. Otherwise (Step S22 in FIG. 7: No), the wireless communication terminal_A2 determines the wireless communication terminal_A1 having transmitted the SVM as the received propagation information, as being a transmission-direction-side terminal. The wireless communication terminal_A2 stores identification information of the terminal as transmission-direction-side terminal information in the transmission-direction-side terminal storage unit 22 of the own terminal_A2 (see Step S23 in FIG. 7, Step S33 in FIG. 8, and dotted lines in FIG. 5).

Subsequently, the wireless communication terminal_A2 further transmits an SVM as the propagation information received as described above to other wireless communication terminals within a range of short-range wireless communication (Step S24 in FIG. 7, and Steps S34 and S35 in FIG. 8). Then, as illustrated in FIG. 4, it is assumed that the wireless communication terminals_A3 and A4 receive the SVM as the propagation information sent from the wireless communication terminal_A2 (Step S21 in FIG. 7: Yes). Then, the wireless communication terminals_A3 and A4 determine whether to newly store transmission-direction-side terminal information (Step S22 in FIG. 7). The determination is made based on information stored in the transmission-direction-side terminal storage unit 22 of the respective own terminals_A3 and A4, and the collecting terminal information and the sending opportunity information included in the received SVM.

At this time, the wireless communication terminals_A3 and A4 do not respectively store transmission-direction-side terminal information based on an SVM being propagation information sent and propagated at the same sending opportunity from the same collecting terminal_A1 (Step S22 in FIG. 7: No). Thus, the wireless communication terminals_A3 and A4 determine the wireless communication terminal_A2 having transmitted the SVM as the received propagation information, as being a transmission-direction-side terminal. The wireless communication terminals_A3 and A4 then store identification information of the terminal as transmission-direction-side terminal information in the transmission-direction-side terminal storage unit 22 of the respective own terminals_A3 and A4 (see Step S23 in FIG. 7, Steps S36 and S37 in FIG. 8, and dotted lines in FIG. 5).

Subsequently, the wireless communication terminal_A3 further transmits an SVM as the propagation information received as described above to other wireless communication terminals within a range of short-range wireless communication (Step S24 in FIG. 7, and Step S38 in FIG. 8). Then, as illustrated with dotted arrows in FIG. 6, it is assumed that the wireless communication terminals_A2, A4, and A5 receive the SVM as the propagation information sent from the wireless communication terminal_A3 (Step S21 in FIG. 7: Yes). Then, the wireless communication terminals_A2, A4, and A5 determine whether to newly store transmission-direction-side terminal information (Step S22 in FIG. 7). The determination is made based on information stored in the transmission-direction-side terminal storage unit 22 of the respective own terminals_A2, A4, and A5 and the collecting terminal information and the sending opportunity information included in the received SVM.

At this time, the wireless communication terminal_A5 does not store transmission-direction-side terminal information based on an SVM being propagation information sent and propagated at the same sending opportunity from the same collecting terminal_A1 (Step S22 in FIG. 7: No). Thus, the wireless communication terminal_A5 determines the wireless communication terminal_A3 having transmitted the SVM as the received propagation information, as being a transmission-direction-side terminal. The wireless communication terminal_A5 then stores identification information of the terminal as transmission-direction-side terminal information in the transmission-direction-side terminal storage unit 22 of the own terminal_A5 (see dotted lines in FIG. 5).

On the other hand, the wireless communication terminal_A4 already stores transmission-direction-side terminal information (A2) based on an SVM being propagation information sent and propagated at the same sending opportunity from the same collecting terminal_A1 (see Step S22 in FIG. 7: No, and dotted lines in FIG. 5). Thus, the wireless communication terminal_A4 does not newly store transmission-direction-side terminal information (Step S39 in FIG. 8).

As described above, an SVM as propagation information sent from the collecting terminal_A1 is propagated among the wireless communication terminals. Accordingly, each of the wireless communication terminals stores another wireless communication terminal being a transmission source from which the SVM is directly received, as a transmission-direction-side terminal. Then, a path formed by tracing the transmission-direction-side terminals stored by the respective wireless communication terminals is established as a data transmission path. The path is, in other words, a path that is reverse to a path through which the propagation information is propagated from the collecting terminal_A1. For example, a path of the terminals A5-A3-A2-A1 as illustrated with the arrow R1 in FIG. 5 and a data transmission path, such as the terminals A4-A2-A1 as illustrated with the arrow R2, from each wireless communication terminal toward the collecting terminal_A1 are established.

Next, an operation at a time of data transmission will be described. Note that, in this example, it is assumed that data transmission paths are established as illustrated with the signs R1 and R2 in FIG. 5. Then, it is assumed that the wireless communication terminal_A1 has data X and the wireless communication terminal_A2 has data Y stored in the data storage device 12 of the respective own terminals, as illustrated in FIG. 9.

In the above-described situation, it is assumed that data Z to be stored in the data storage unit 12 are generated within the wireless communication terminal_A3 illustrated in FIG. 9 (Step S41 in FIG. 10: Yes, and Step S51 in FIG. 11). Then, the wireless communication terminal_A3 transmits an SVM representing a list of data stored in the data storage unit 12 of the own terminal to other wireless communication terminals located within a range of short-range wireless communication (Step S42 in FIG. 10). At this time, the wireless communication terminals_A2, A4, and A5 are located within the range of short-range wireless communication. The respective wireless communication terminals_A2, A4, and A5 receive the SVM transmitted from the wireless communication terminal_A3 (see dotted lines in FIG. 9, and Steps S52 and S53 in FIG. 11). The wireless communication terminals_A2, A4, and A5 having received the SVM from the wireless communication terminal_A3 transmit an SVM representing a list of data stored in the respective own terminals to the wireless communication terminal_A3 (Steps S54 and S55 in FIG. 11). In this manner, the wireless communication terminal_A3 performs SVM exchange with the respective wireless communication terminals_A2, A4, and A5.

The wireless communication terminal_A3 specifies a transmission-direction-side terminal of which transmission-direction-side terminal information is stored in the transmission-direction-side terminal storage unit 22 of the own terminal_A3 (Step S43 in FIG. 10). The wireless communication terminal_A3 specifies the transmission-direction-side terminal from among the respective wireless communication terminals_A2, A4, and A5 with which SVM exchange has been performed. Herein, as illustrated in FIGS. 5 and 9, only the wireless communication terminal_A2 is the transmission-direction-side terminal of the wireless communication terminal_A3.

The wireless communication terminal_A3 then specifies, based on the exchanged SVMs, data Z that the own terminal_A3 holds yet the wireless communication terminal_A2 being the transmission-direction-side terminal does not hold. The wireless communication terminal_A3 transmits the data Z to only the wireless communication terminal_A2 being the transmission-direction-side terminal (Step S44 in FIG. 10, and Step S56 in FIG. 11). Accordingly, the data Z stored in the wireless communication terminal_A3 are collected by the wireless communication terminal_A2, and the wireless communication terminal_A2 comes into a state of storing the data Y and the data Z (Step S57 in FIG. 11). At this time, no data are transmitted from the wireless communication terminal_A3 to the wireless communication terminals_A4 and A5. In addition, no data are transmitted from the wireless communication terminal_A2 to the wireless communication terminal_A3, either.

As described above, when the data Z that the wireless communication terminal_A3 holds are stored in the wireless communication terminal_A2, data stored in the wireless communication terminal_A2 change (Step S41 in FIG. 10). Then, the wireless communication terminal_A2 transmits an SVM representing a list of data stored in the data storage unit 12 of the own terminal to other wireless communication terminals located within a range of short-range wireless communication (Step S42 in FIG. 10). At this point of time, the wireless communication terminal_A1 is located within the range of short-range wireless communication. Thus, the wireless communication terminal_A1 receives the SVM transmitted from the wireless communication terminal_A2 (Step S58 in FIG. 11). The wireless communication terminal_A1 having received the SVM from the wireless communication terminal_A2 transmits an SVM representing a list of data stored in the own terminal to the wireless communication terminal_A2 (Step S59 in FIG. 11). In this manner, the wireless communication terminal_A2 performs SVM exchange with the wireless communication terminal_A1.

The wireless communication terminal_A2 confirms that the wireless communication terminal_A1 with which SVM exchange has been performed is a transmission-direction-side terminal of which transmission-direction-side terminal information is stored in the transmission-direction-side terminal storage unit 22 of the own terminal_A2 (Step S43 in FIG. 10). The wireless communication terminal_A2 then specifies, based on the exchanged SVMs, data Y and data Z that the own terminal_A2 holds yet the wireless communication terminal_A1 being the transmission-direction-side terminal does not hold. The wireless communication terminal_A2 transmits the data Y and the data Z to only the wireless communication terminal_A1 being the transmission-direction-side terminal (Step S44 in FIG. 10, and Step 60 in FIG. 11). Accordingly, the data Y and the data Z stored in the wireless communication terminal_A2 are collected by the wireless communication terminal_A1, and the wireless communication terminal_A1 comes into a state of storing the data X, the data Y, and the data Z (Step S61 in FIG. 11). At this time, no data are transmitted from the wireless communication terminal_A2 to any other wireless communication terminals.

As described above, each of the wireless communication terminals relays and transmits data to only a stored transmission-direction-side terminal. Accordingly, the data are collected in a transmission direction along an established data transmission path as described above, and the data are resultantly collected by the collecting terminal_A1. At this time, no data are transmitted through a path other than the established data transmission path. This makes it possible to prevent increase in an amount of traffic in a network while appropriately transmitting data to a desired terminal. As a result, improvement in data transmission efficiency can be achieved.

### Example Embodiment 2

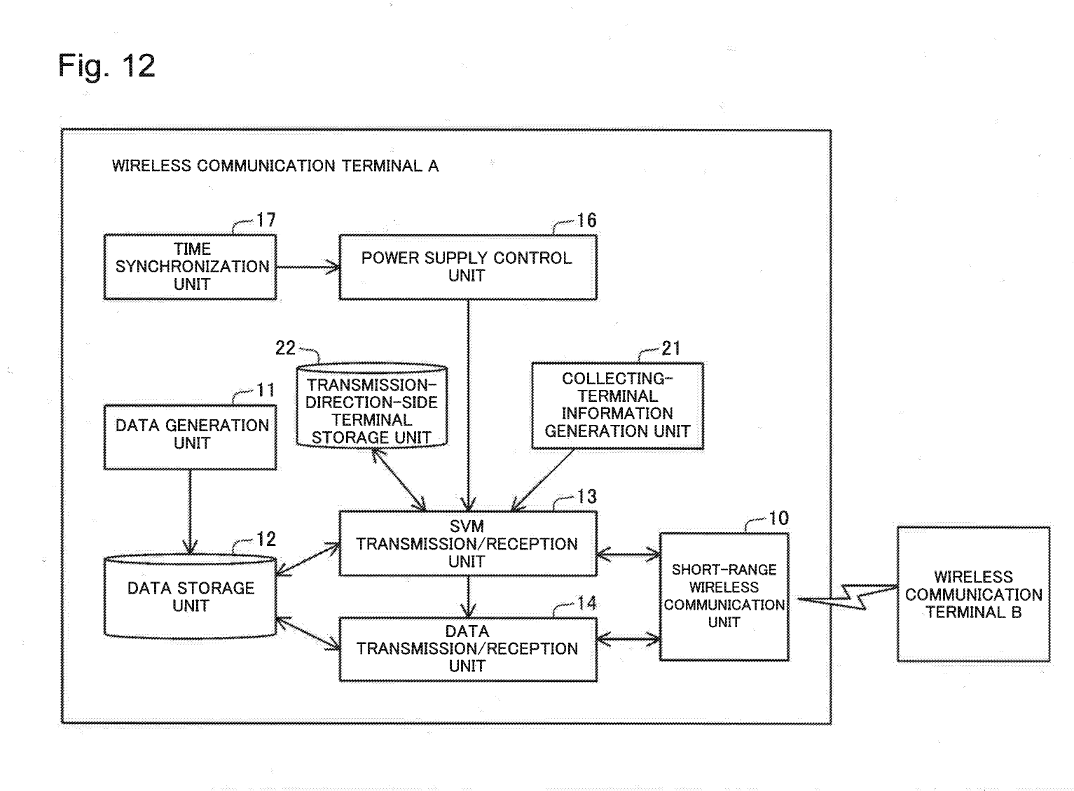

Next, a second example embodiment of the present invention will be described with reference to FIG. 12. FIG. 12 is a block diagram illustrating a configuration of a wireless communication terminal.

A wireless communication terminal_A according to the present example embodiment has a configuration for performing data transmission, being different from that of the above-described example embodiment 1. The wireless communication terminal_A according to the present example embodiment is configured to be activated concurrently with another wireless communication terminal_B located within a range of short-range wireless communication and perform data transmission. With this configuration, reduction in an amount of power consumption of the wireless communication terminals_A and B is attempted.

As illustrated in FIG. 12, the wireless communication terminal_A according to the present example embodiment includes, in addition to the configuration of the above-described example embodiment 1, a power supply control unit 16 and a time synchronization unit 17. Note that the power supply control unit 16 and the time synchronization unit 17 are implemented by incorporating a program in an arithmetic operation device equipped in the wireless communication terminal_A.

The time synchronization unit 17 manages internal time of the wireless communication terminal_A, and sets the internal time by using, for example, a GPS. Accordingly, the internal time of the wireless communication terminal_A is synchronized with internal time set in the other terminal_B. Note that the synchronization of time of the respective terminals may be performed by using another method.

The power supply control unit 16 functions as an activation control unit. The activation control unit controls an activation state of a preset configuration to be activated including at least an SVM transmission/reception unit 13 and a data transmission/reception unit 14 functioning as the above-described data transmission/reception unit. In the present example embodiment, it is assumed that the configuration to be activated includes a configuration that executes processing of confirming that data are transmitted to only a transmission-direction-side terminal and the data are stored in the transmission-direction-side terminal. It is also assumed that the configuration to be activated includes a configuration that executes processing of confirming that the own terminal receives data from another wireless communication terminal and the data are stored in the own terminal.

Specifically, when a preset time elapses based on the internal time managed by the time synchronization unit 17, the power supply control unit 16 activates the configuration to be activated from a sleep state to active state. In other words, the power supply control unit 16 periodically activates the configuration to be activated. Note that the sleep state refers to a state of operating with less power than in the active state, or a state in which the configuration to be activated is not supplied with power.

Accordingly, all of the wireless communication terminals_A and B in which the same time is set are activated at the same timing. Then, as described above, the terminals_A and B capable of short-range wireless communication thereafter perform short-range wireless communication mutually and exchange SVMs. Then, the terminals_A and B perform data transmission in a transmission direction along a data transmission path.

In addition, after completion of the above-described data transmission, the power supply control unit 16 sets the configuration to be activated including the SVM transmission/reception unit 13 and the data transmission/reception unit 14 into a sleep state (non-active state). Note that the completion of data transmission is determined by acquiring a result of SVM exchange from the SVM transmission/reception unit 13 and confirming that all pieces of data of other terminals are collected and stored in a specific terminal being a transmission-direction-side terminal. However, the confirmation of data transmission completion may be performed by using another method.

As described above, in the wireless communication device and the wireless communication method according to the present invention, wireless communication terminals each being a mobile body are periodically activated at the same timing. In addition, data transmission is performed along a data transmission path. Thus, the wireless communication device is not required to be always active, which can achieve power saving by preventing lowering of a battery. In addition, the wireless communication terminal is prevented from being always powered off, which allows transmission of data to a remotely located collecting terminal. Herein, the above-described time synchronization unit 17 is not necessarily required to be equipped, and the time may be different to some extent between the wireless communication terminals_A and B. Even in the case, when the configuration to be activated is activated by the power supply control unit 16, the wireless communication terminals_A and B are activated concurrently. Note that the configurations to be activated in the wireless communication terminals_A and B are required to be activated concurrently within a period of time during which data synchronization processing is executed.

### Example Embodiment 3

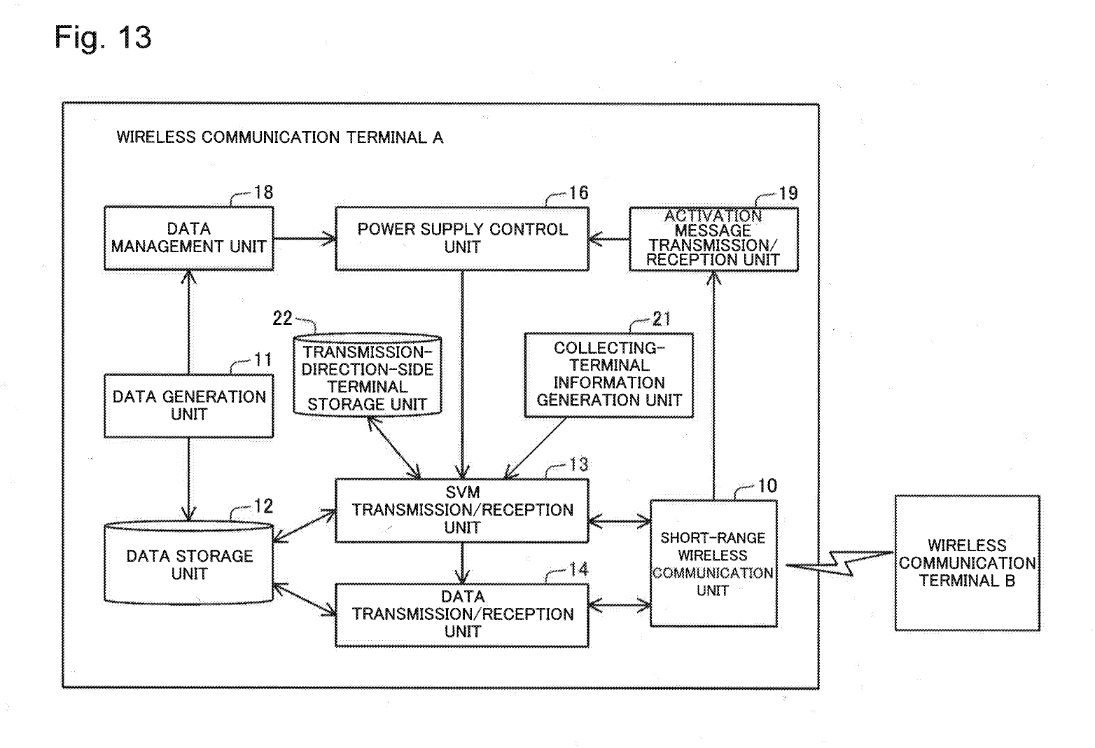

Next, a third example embodiment of the present invention will be described with reference to FIG. 13. FIG. 13 is a block diagram illustrating a configuration of a wireless communication terminal.

[Configuration]

A wireless communication terminal_A according to the present example embodiment has a configuration for performing data transmission, being different from that of the above-described example embodiment 2. In other words, a method of activating a configuration to be activated including at least an SVM transmission/reception unit 13 and a data transmission/reception unit 14 is different. Thus, the wireless communication terminal_A according to the present example embodiment has a configuration substantially similar to that of the example embodiment 2, but has a different function of a power supply control unit 16. In addition, as illustrated in FIG. 13, the wireless communication terminal_A according to the present example embodiment newly includes a data management unit 18 and an activation message transmission/reception unit 19. The data management unit 18 and the message transmission/reception unit 19 are implemented by incorporating a program in an arithmetic operation device equipped in the wireless communication terminal_A.

The data management unit 18 manages change in data stored in a data storage unit 12. Specifically, the data management unit 18 detects that data to be stored in the data storage unit 12 are generated by a data generation unit 11, and notifies the power supply control unit 16 of occurrence of change in data in the data storage unit 12.

Upon receiving a notification of occurrence of change in data in the data storage unit 12 from the data management unit 18, the power supply control unit 16 activates a configuration to be activated including at least the SVM transmission/reception unit 13 and the data transmission/reception unit 14. At this time, the power supply control unit 16 controls not only a configuration to be activated of the own terminal_A, but also a configuration to be activated of another wireless communication terminal_B located within a range of short-range wireless communication. The power supply control unit 16 controls the configuration to be activated of the own terminal_A and the configuration to be activated of the other wireless communication terminal_B so as to be activated at the substantially same timing, in other words, concurrently. Specifically, the power supply control unit 16 transmits a Wakeup message to the other wireless communication terminal_B within the range of short-range wireless communication via the activation message transmission/reception unit 19. The Wakeup message is a signal for instructing activation. At this time, the Wakeup message is transmitted by broadcasting, but may be transmitted by using any method.

On the other hand, the activation message transmission/reception unit 19 is configured to be capable of always receiving a Wakeup message from the other wireless communication terminal_B. Upon receiving a Wakeup message from the other terminal_B, the activation message transmission/reception unit 19 notifies the power supply control unit 16. The power supply control unit 16 then activates the configuration to be activated of the own terminal_A.

In this manner, in the present example embodiment, with change in data stored in a certain wireless communication terminal as a trigger, all wireless communication terminals located within a range of short-range wireless communication are activated. Then, as described above, the terminals_A and B capable of short-range wireless communication thereafter perform short-range wireless communication mutually and exchange SVMs. Then, the terminals_A and B perform data transmission in a transmission direction along a data transmission path.

Note that, in order to implement such a configuration, a wireless communication terminal being a transmission side of data needs to detect change in data and a Wakeup message. Thus, it is assumed that the power supply control unit 16, the data management unit 18, and the activation message transmission/reception unit 19 are always in an activated state and these configurations are not included in the configuration to be activated. However, the data management unit 18 in a wireless communication terminal on a reception side does not need to be always active, and the data management unit 18 may be included in the configuration to be activated.

In addition, after completion of the above-described data transmission, the power supply control unit 16 sets the configuration to be activated including the SVM transmission/reception unit 13 and the data transmission/reception unit 14 into a sleep state (non-active state). Note that the completion of data transmission is determined by acquiring a result of SVM exchange from the SVM transmission/reception unit 13 and confirming that all pieces of data of other terminals are stored in a specific terminal being a transmission-direction-side terminal. However, the confirmation of data transmission completion may be performed by using another method.

### Example Embodiment 4

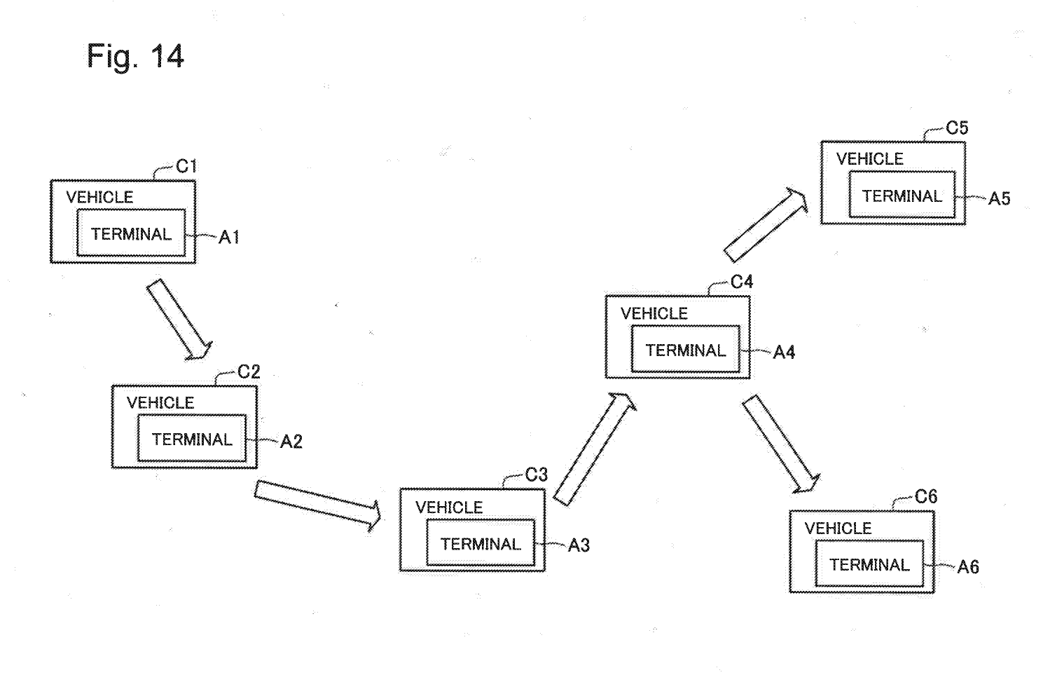

Next, a fourth example embodiment of the present invention will be described with reference to FIG. 14. FIG. 14 is a diagram illustrating a configuration and an operation of a wireless communication terminal according to the present example embodiment.

Wireless communication terminals_A1 to A6 according to the present example embodiment respectively include the same configuration as that described in each of the above-described example embodiments. Then, the wireless communication terminals_A1 to A6 are respectively equipped in vehicles C1 to C6. Note that it is assumed that the wireless communication terminals_A1 to A6 and the vehicles C1 to C6 respectively have the same configuration. However, the wireless communication terminals_A1 to A6 and the vehicles C1 to C6 may respectively have different configurations.

The wireless communication terminal_A1 in a situation described above is equipped with configurations having particularly the following functions. First, a data generation unit 11 collects or generates data representing a status of the vehicle C1, and stores the data in a data storage unit 12. For example, the data to be generated by the data generation unit 11 are movement history based on positional information acquired by a GPS equipped in the vehicle C1, and information such as a use status of an engine of the vehicle C1 (a rotation speed and the like) and a distance travelled.

In addition, an SVM transmission/reception unit 13 and a data transmission/reception unit 14, and further, a power supply control unit 16 of the wireless communication terminal_A1 are configured to operate regardless of a state of the vehicle C1. The SVM transmission/reception unit 13 and the data transmission/reception unit 14 are a configuration that executes data transmission, and the power supply control unit 16 has been described in the example embodiments 2 and 3. For example, even when the engine of the vehicle C1 is stopped, the SVM transmission/reception unit 13, the data transmission/reception unit 14, and the power supply control unit 16 are configured to always operate, operate at a fixed period, or operate with generation of data as a trigger, as described in the example embodiments 1 to 3.

As described above, by equipping the wireless communication terminal_A1 according to the present invention in the vehicle C1, wireless communication terminals equipped in moving vehicles are able to relay and transmit data by means of short-range wireless communication while accumulating the data. Thus, it also becomes possible to transmit data to a terminal of a distant vehicle located outside a range of short-range wireless communication, and data can be collected by a collecting terminal equipped in a specific vehicle. For example, as illustrated with arrows in FIG. 14, even among vehicles being unable to directly communicate with each other by means of short-range wireless communication, data of the vehicles C1 to C4 can be collected in the vehicle C6. Then, especially, data are transmitted along an established data transmission path. This makes it possible to prevent increase in an amount of traffic in a network while appropriately transmitting data to a desired terminal. As a result, improvement in data transmission efficiency can be achieved.

### <Supplementary Notes>

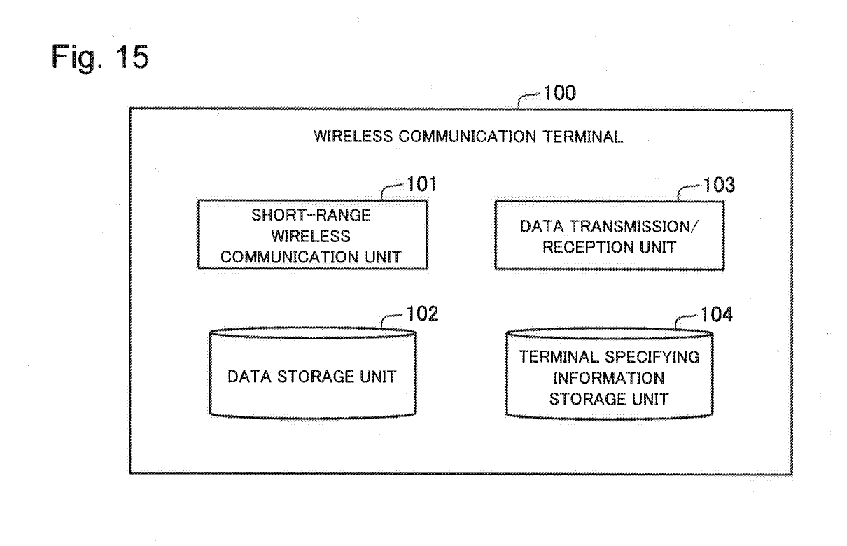

A part or all of the example embodiments can be described as the following supplementary notes. Hereinafter, a configuration of a wireless communication terminal (see FIG. 15), a program, and an information processing method according to the present invention will be schematically described. However, the present invention is not limited to the following configuration.

### (Supplementary Note 1)

A wireless communication terminal 100 comprising:

a short-range wireless communication unit 101 that performs short-range wireless communication mutually with another wireless communication terminal within a range of short-range wireless communication;

a data storage unit 102 that stores specific data;

a data transmission/reception unit 103 that transmits and receives data stored in the data storage unit to and from another wireless communication terminal by means of short-range wireless communication; and

a terminal specifying information storage unit 104 that stores transmission-direction-side terminal specifying information that is information specifying a transmission-direction-side wireless communication terminal being another wireless communication terminal located adjacent to an own terminal in a data transmission direction on a path established to transmit data from the own terminal via another wireless communication terminal by means of short-range wireless communication, wherein

the data transmission/reception unit 103 transmits data stored in the data storage unit of the own terminal by means of short-range wireless communication to only the transmission-direction-side wireless communication terminal specified in the transmission-direction-side terminal specifying information among other wireless communication terminals within a range of short-range wireless communication, and receives and stores data transmitted by means of short-range wireless communication from another wireless communication terminal in the data storage unit.

According to the invention of the above configuration, first, a wireless communication terminal, when other wireless communication terminals are located within a range of short-range wireless communication, performs short-range wireless communication with the other wireless communication terminals. Then, the wireless communication terminal transmits and receives data to and from another wireless communication terminal by means of short-range wireless communication. Then, the other wireless communication terminal having transmitted and received data also transmits and receives data to and from still another wireless communication terminal by means of short-range wireless communication. Accordingly, it is possible to propagate data to even a remotely located wireless communication terminal.

Herein, the wireless communication terminal stores transmission-direction-side terminal specifying information that specifies a transmission-direction-side wireless communication terminal. The transmission-direction-side wireless communication terminal is another wireless communication terminal located adjacent to the own terminal in a data transmission direction on a path established in advance. Thus, the wireless communication terminal, when other wireless communication terminals are located within a range of short-range wireless communication, transmits data to only the transmission-direction-side wireless communication terminal on the path specified in the transmission-direction-side terminal specifying information. In other words, the wireless communication terminal does not transmit data to other wireless communication terminals located within the range of short-range wireless communication that are not the transmission-direction-side wireless communication terminal on the path.

This prevents wasteful data transmission at a time of data transmission by a wireless communication terminal, and makes it possible to appropriately transmit data to a terminal on a data transmission-direction side on a path. As a result, an amount of traffic in a wireless communication network is reduced and data can be aggregated in a desired terminal, and improvement in data transmission efficiency can be achieved.

### (Supplementary Note 2)

The wireless communication terminal according to Supplementary note 1, wherein

the data transmission/reception unit performs wireless communication mutually with the transmission-direction-side wireless communication terminal within a range of short-range wireless communication, and transmits data not stored in the transmission-direction-side wireless communication terminal among data stored in the data storage unit of the own terminal, to the transmission-direction-side wireless communication terminal.

### (Supplementary Note 3)

The wireless communication terminal according to Supplementary note 2, wherein

the data transmission/reception unit performs wireless communication mutually with only the transmission-direction-side wireless communication terminal within a range of short-range wireless communication, transmits and receives a list of data stored in the data storage unit of the own terminal and a list of data stored in the transmission-direction-side wireless communication terminal, compares the lists, and transmits, based on the lists, data not stored in the transmission-direction-side wireless communication terminal among data stored in the data storage unit of the own terminal, to the transmission-direction-side wireless communication terminal.

### (Supplementary Note 4)

The wireless communication terminal according to any one of Supplementary notes 1 to 3, wherein

the data transmission/reception unit, when transmitting data by using epidemic routing, transmits data stored in the data storage unit of the own terminal by means of short-range wireless communication to only the transmission-direction-side wireless communication terminal.

According to the invention of the above configuration, a wireless communication terminal transmits only data that are not stored in a transmission-direction-side wireless communication terminal from the own terminal. Accordingly, an amount of traffic in a network can be further reduced. In addition, the wireless communication terminal, for example, at a time of data transmission by using a method such as epidemic routing, transmits and receives a list of data to and from only the transmission-direction-side wireless communication terminal for data transmission. Accordingly, an amount of traffic in a network can be further reduced.

### (Supplementary Note 5)

The wireless communication terminal according to any one of Supplementary notes 1 to 4, further comprising

a terminal specifying information processing unit that, when receiving, from another wireless communication terminal within a range of short-range wireless communication, propagation information sent and propagated from a specific wireless communication terminal, specifies the another wireless communication terminal as being the transmission-direction-side wireless communication terminal located adjacent on a data transmission-direction side of the own terminal on the path, and stores the transmission-direction-side terminal specifying information that is information specifying the transmission-direction-side wireless communication terminal, in the terminal specifying information storage unit.

According to the invention of the above configuration, it is assumed that a wireless communication terminal receives, from another wireless communication terminal within a range of short-range wireless communication, propagation information sent and propagated from a specific wireless communication terminal. In this case, the wireless communication terminal specifies the another wireless communication terminal as being the above-described transmission-direction-side wireless communication terminal. Accordingly, data are transmitted and collected from the wireless communication terminal toward the specific wireless communication terminal only through a path that is reverse to a path through which the propagation information is propagated from the specific wireless communication terminal. As a result, an amount of traffic in a wireless communication network is reduced and data can be aggregated in a desired terminal, and improvement in data transmission efficiency can be achieved.

### (Supplementary Note 6)

The wireless communication terminal according to Supplementary note 5, wherein

the terminal specifying information processing unit, when receiving, from a plurality of other wireless communication terminals within a range of short-range wireless communication, the propagation information propagated from the specific wireless communication terminal, specifies only another single wireless communication terminal out of the plurality of other wireless communication terminals, as being the transmission-direction-side wireless communication terminal, and stores the transmission-direction-side terminal specifying information specifying the transmission-direction-side wireless communication terminal in the terminal specifying information storage unit.

### (Supplementary Note 7)

The wireless communication terminal according to Supplementary note 5, wherein

the terminal specifying information processing unit, when receiving, from a plurality of other wireless communication terminals within a range of short-range wireless communication, the propagation information sent and propagated at a same opportunity from the specific wireless communication terminal, specifies only another single wireless communication terminal determined based on a preset reference out of the plurality of other wireless communication terminals, as being the transmission-direction-side wireless communication terminal, and stores the transmission-direction-side terminal specifying information specifying the transmission-direction-side wireless communication terminal, in the terminal specifying information storage unit.

### (Supplementary Note 8)

The wireless communication terminal according to Supplementary note 7, wherein

the terminal specifying information processing unit, when the received propagation information is propagation information sent and propagated from the specific wireless communication terminal at an opportunity later than a sending opportunity of the propagation information as a trigger for storing the transmission-direction-side terminal specifying information stored in the terminal specifying information storage unit, specifies another wireless communication terminal from which the propagation information is received, as being the transmission-direction-side wireless communication terminal, and updates and stores the transmission-direction-side terminal specifying information specifying the transmission-direction-side wireless communication terminal, in the terminal specifying information storage unit.

### (Supplementary Note 9)

The wireless communication terminal according to any one of Supplementary notes 5 to 8, wherein

the terminal specifying information reception unit, when receiving, from another wireless communication terminal within a range of short-range wireless communication, the propagation information propagated from the specific wireless communication terminal, transmits the propagation information so as to be propagated by using epidemic routing to still another wireless communication terminal within the range of short-range wireless communication.

According to the invention of the above configuration, it is assumed that a wireless communication terminal receives, from a plurality of other wireless communication terminals, propagation information sent and propagated from a specific wireless communication terminal via various paths. Even in this case, the wireless communication terminal specifies one transmission-direction-side wireless communication terminal. Accordingly, one path for transmitting data from the wireless communication terminal toward the specific wireless communication terminal is specified. Thus, an amount of traffic in a network is reduced and improvement in data transmission efficiency can be achieved.

In addition, it is assumed that a specific wireless communication terminal sends propagation information a plurality of times. Even in this case, a wireless communication terminal specifies another wireless communication terminal from which latest propagation information is received, as being a transmission-direction-side wireless communication terminal. Accordingly, a path for transmitting data from the wireless communication terminal toward the specific wireless communication terminal is updated in accordance with a positional relationship between the wireless communication terminals. Thus, improvement in data transmission efficiency can be further achieved.

### (Supplementary Note 10)

The wireless communication terminal according to any one of Supplementary notes 1 to 9, further comprising

an activation control unit that causes a configuration to be activated including at least the data transmission/reception unit, to be activated concurrently with activation of the configuration to be activated equipped in another wireless communication terminal, and to operate to perform data transmission and reception.

According to the invention of the above configuration, a wireless communication terminal is capable of transmitting data by being activated concurrently with another wireless communication terminal. Thus, the wireless communication terminal is not required to be always active, which can achieve power saving by preventing lowering of a battery.

### (Supplementary Note 10-1)

The wireless communication terminal according to Supplementary note 10, wherein

the activation control unit activates the configuration to be activated at a preset period.

### (Supplementary Note 10-3)

The wireless communication terminal according to Supplementary note 10-2, wherein

the activation control unit synchronizes time with another wireless communication terminal, and activates, based on the synchronized time, the configuration to be activated at a preset period.

### (Supplementary Note 10-4)

The wireless communication terminal according to any one of Supplementary notes 10 to 10-3, wherein

the activation control unit activates, in accordance with change in data stored in the data storage unit, the configuration to be activated equipped in the own terminal concurrently with activation of the configuration to be activated equipped in another wireless communication terminal.

### (Supplementary Note 10-5)

The wireless communication terminal according to Supplementary note 10-4, wherein

the activation control unit, when change in data stored in the data storage unit occurs, activates the configuration to be activated of the own terminal, and sends a signal for activating the configuration to be activated of another wireless communication terminal via the wireless communication unit.

### (Supplementary Note 10-6)

The wireless communication terminal according to any one of Supplementary notes 10 to 10-5, wherein

the activation control unit, when the data transmission/reception unit completes data transmission performed by the data transmission/reception unit with another wireless communication terminal within a range of short-range wireless communication, sets the configuration to be activated into a non-active state.

### (Supplementary Note 10-7)

The wireless communication terminal according to any one of Supplementary notes 10 to 10-6, wherein

the wireless communication terminal is equipped in a vehicle, and

the activation control unit operates regardless of a state of the vehicle.

### (Supplementary Note 11)

The wireless communication terminal according to any one of Supplementary notes 1 to 10, wherein

the configuration to be activated includes a configuration that transmits and receives data to and from another wireless communication terminal and executes processing of confirming that the transmitted and received data are stored in the own terminal or another wireless communication terminal.

### (Supplementary Note 12)

A vehicle being equipped with the wireless communication terminal according to any one of Supplementary notes 1 to 11.

According to the invention of the above configuration, by equipping the above-described wireless communication terminal in a vehicle, even when the vehicle moves around, data can be collected in a specific vehicle while preventing increase in an amount of traffic in a network. As a result, improvement in data transmission efficiency can be achieved.

### (Supplementary Note 13)

A program for causing a control device of a wireless communication terminal including a short-range wireless communication unit that performs short-range wireless communication mutually with another wireless communication terminal within a range of short-range wireless communication, and a data storage unit that stores specific data, to implement:

a data transmission/reception unit that transmits and receives data stored in the data storage unit to and from another wireless communication terminal by means of short-range wireless communication; and

a terminal specifying information storage unit that stores transmission-direction-side terminal specifying information that is information specifying a transmission-direction-side wireless communication terminal being another wireless communication terminal located adjacent to an own terminal in a data transmission direction on a path established to transmit data from the own terminal via another wireless communication terminal by means of short-range wireless communication, and further implement that

the data transmission/reception unit transmits data stored in the data storage unit of the own terminal by means of short-range wireless communication to only the transmission-direction-side wireless communication terminal specified in the transmission-direction-side terminal specifying information among other wireless communication terminals within a range of short-range wireless communication, and receives and stores data transmitted by means of short-range wireless communication from another wireless communication terminal, in the data storage unit.

### (Supplementary Note 14)

The program according to Supplementary note 13, wherein

the data transmission/reception unit performs wireless communication mutually with the transmission-direction-side wireless communication terminal within a range of short-range wireless communication, and transmits data not stored in the transmission-direction-side wireless communication terminal among data stored in the data storage unit of the own terminal, to the transmission-direction-side wireless communication terminal.

### (Supplementary Note 15)

The program according to Supplementary note 13 or 14, for causing the control device to further implement

a terminal specifying information processing unit that, when receiving, from another wireless communication terminal within a range of short-range wireless communication, propagation information sent and propagated from a specific wireless communication terminal, specifies the another wireless communication terminal as being the transmission-direction-side wireless communication terminal located adjacent on a data transmission-direction side of the own terminal on the path, and stores the transmission-direction-side terminal specifying information that is information specifying the transmission-direction-side wireless communication terminal, in the terminal specifying information storage unit.

### (Supplementary Note 16)

An information processing method, wherein

a wireless communication terminal including a short-range wireless communication unit that performs short-range wireless communication mutually with another wireless communication terminal within a range of short-range wireless communication, and a data storage unit that stores specific data

stores transmission-direction-side terminal specifying information that is information specifying a transmission-direction-side wireless communication terminal being another wireless communication terminal located adjacent to an own terminal in a data transmission direction on a path established to transmit data from the own terminal via another wireless communication terminal by means of short-range wireless communication,

the wireless communication terminal is configured to transmit and receive data stored in the data storage unit to and from another wireless communication terminal by means of short-range wireless communication, and

further, the wireless communication terminal transmits data stored in the data storage unit of the own terminal by means of short-range wireless communication to only the transmission-direction-side wireless communication terminal specified in the transmission-direction-side terminal specifying information among other wireless communication terminals within a range of short-range wireless communication.

### (Supplementary Note 17)

The information processing method according to Supplementary note 16, wherein

the wireless communication terminal performs wireless communication mutually with the transmission-direction-side wireless communication terminal within a range of short-range wireless communication, and transmits data not stored in the transmission-direction-side wireless communication terminal among data stored in the data storage unit of the own terminal, to the transmission-direction-side wireless communication terminal.

### (Supplementary Note 18)

The information processing method according to Supplementary note 16 or 17, wherein

the wireless communication terminal, when receiving, from another wireless communication terminal within a range of short-range wireless communication, propagation information sent and propagated from a specific wireless communication terminal, specifies the another wireless communication terminal as being the transmission-direction-side wireless communication terminal located adjacent on a data transmission-direction side of the own terminal on the path, and stores the transmission-direction-side terminal specifying information that is information specifying the transmission-direction-side wireless communication terminal, in the terminal specifying information storage unit.

Note that the program described above is stored in a storage device, or is recorded in a computer-readable recording medium. For example, the recording medium is a portable medium such as a flexible disk, an optical disk, a magneto-optical disk, and a semiconductor memory.

In the above, the present invention has been described with reference to the example embodiments and the like. However, the present invention is not limited to the example embodiments described above. Various modifications that can be understood by those skilled in the art can be made to the configurations and details of the present invention within the scope of the present invention.

Note that the present invention is based upon and enjoys the benefit of priority from Japanese Patent Application No. 2014-241947, filed on Nov. 28, 2014 in Japan, and the content described in the patent application is incorporated herein in its entirety.

### REFERENCE SIGNS LIST

A, A1 to A6, B Wireless communication terminal
C1 to C6 Vehicle
10 Short-range wireless communication unit
11 Data generation unit
12 Data storage unit
13 SVM transmission/reception unit
14 Data transmission/reception unit
16 Power supply control unit
17 Time synchronization unit
18 Data management unit
19 Activation message transmission/reception unit
21 Collecting-terminal information generation unit
22 Transmission-direction-side terminal storage unit
100 Wireless communication terminal
101 Short-range wireless communication unit
102 Data storage unit
103 Data transmission/reception unit
104 Terminal specifying information storage unit

What is claimed is:

1. A wireless communication terminal comprising:
a short-range wireless communication unit that performs short-range wireless communication mutually with another wireless communication terminal within a range of short-range wireless communication;
a data storage that stores data;
one or more processors acting as a data transmission/reception unit that transmits and receives the data stored in the data storage to and from the another wireless communication terminal by means of the short-range wireless communication; and
a terminal specifying information storage that stores transmission-direction-side terminal specifying information that is information specifying a transmission-direction-side wireless communication terminal being a wireless communication terminal located adjacent to an own terminal in a data transmission direction on a path established to transmit the data from the own terminal via the another wireless communication terminal by means of the short-range wireless communication, wherein
the data transmission/reception unit transmits the data stored in the data storage of the own terminal by means of the short-range wireless communication to only the transmission-direction-side wireless communication terminal specified in the transmission-direction-side terminal specifying information among other wireless communication terminals within the range of the short-range wireless communication, and receives data transmitted by means of the short-range wireless communication from the another wireless communication terminal and stores the received data in the data storage.

2. The wireless communication terminal according to claim 1, wherein
the data transmission/reception unit performs wireless communication mutually with the transmission-direction-side wireless communication terminal within the range of the short-range wireless communication, and transmits data not stored in the transmission-direction-side wireless communication terminal among the data stored in the data storage of the own terminal, to the transmission-direction-side wireless communication terminal.

3. The wireless communication terminal according to claim 2, wherein
the data transmission/reception unit performs wireless communication mutually with only the transmission-direction-side wireless communication terminal within the range of the short-range wireless communication, transmits and receives a list of the data stored in the data storage of the own terminal and a list of data stored in the transmission-direction-side wireless communication terminal, compares the lists, and transmits, based on the lists, the data not stored in the transmission-direction-side wireless communication terminal among the data stored in the data storage of the own terminal, to the transmission-direction-side wireless communication terminal.

4. The wireless communication terminal according to claim 1, wherein
the data transmission/reception unit, when transmitting data by using epidemic routing, transmits the data stored in the data storage of the own terminal by means of the short-range wireless communication to only the transmission-direction-side wireless communication terminal.

5. The wireless communication terminal according to claim 1, further comprising
the one or more processors acting as a terminal specifying information processing unit that, when receiving, from the another wireless communication terminal within the range of the short-range wireless communication, propagation information sent and propagated from a specific wireless communication terminal, specifies the another wireless communication terminal as being the transmission-direction-side wireless communication terminal located adjacent on a data transmission-direction side of the own terminal on the path, and stores the transmission-direction-side terminal specifying information that is information specifying the transmission-direction-side wireless communication terminal, in the terminal specifying information storage.

6. The wireless communication terminal according to claim 5, wherein
the terminal specifying information processing unit, when receiving, from a plurality of other wireless communication terminals within the range of the short-range wireless communication, the propagation information propagated from the specific wireless communication terminal, specifies only another single wireless communication terminal out of the plurality of other wireless communication terminals, as being the transmission-direction-side wireless communication terminal, and stores the transmission-direction-side terminal specifying information specifying the transmission-direction-side wireless communication terminal in the terminal specifying information storage.

7. The wireless communication terminal according to claim 5, wherein
the terminal specifying information processing unit, when receiving, from a plurality of other wireless communication terminals within the range of the short-range wireless communication, the propagation information sent and propagated at a same opportunity from the specific wireless communication terminal, specifies only another single wireless communication terminal determined based on a preset reference out of the plurality of other wireless communication terminals, as being the transmission-direction-side wireless communication terminal, and stores the transmission-direction-side terminal specifying information specifying the transmission-direction-side wireless communication terminal, in the terminal specifying information storage.

8. The wireless communication terminal according to claim 7, wherein
the terminal specifying information processing unit, when the received propagation information is propagation information sent and propagated from the specific wireless communication terminal at an opportunity later than a sending opportunity of the propagation information as a trigger for storing the transmission-direction-side terminal specifying information stored in the terminal specifying information storage, specifies the another wireless communication terminal from which the propagation information is received, as being the transmission-direction-side wireless communication terminal, and updates and stores the transmission-direction-side terminal specifying information specifying the transmission-direction-side wireless communication terminal, in the terminal specifying information storage.

9. The wireless communication terminal according to claim 5, wherein
the terminal specifying information processing unit, when receiving, from another wireless communication terminal within the range of the short-range wireless communication, the propagation information propagated from the specific wireless communication terminal, transmits the propagation information so as to be propagated by using epidemic routing to still another wireless communication terminal within the range of short-range wireless communication.

10. The wireless communication terminal according to claim 1, further comprising
the one or more processors acting as an activation control unit that causes a configuration to be activated including at least the data transmission/reception unit, to be activated concurrently with activation of the configuration to be activated equipped in the another wireless communication terminal, and to operate to perform data transmission and reception.

11. The wireless communication terminal according to claim 1, wherein
the configuration to be activated includes a configuration that transmits and receives data to and from the another wireless communication terminal and executes processing of confirming that the transmitted and received data are stored in the own terminal or the another wireless communication terminal.

12. A vehicle being equipped with the wireless communication terminal according to claim 1.

13. A non-transitory computer readable storage medium storing program for causing a control device of a wireless communication terminal including a short-range wireless communication unit that performs short-range wireless communication mutually with another wireless communication terminal within a range of short-range wireless communication, and a data storage that stores data, to perform:
transmitting and receiving the data stored in the data storage unit to and from the another wireless communication terminal by means of the short-range wireless communication; and
storing transmission-direction-side terminal specifying information that is information specifying a transmission-direction-side wireless communication terminal being a wireless communication terminal located adjacent to an own terminal in a data transmission direction on a path established to transmit the data from the own terminal via the another wireless communication terminal by means of the short-range wireless communication,
in the transmitting and receiving data, transmitting the data stored in the data storage unit of the own terminal by means of the short-range wireless communication to only the transmission-direction-side wireless communication terminal specified in the transmission-direction-side terminal specifying information among other wireless communication terminals within the range of the short-range wireless communication, and receiving data transmitted by means of the short-range wireless communication from the another wireless communication terminal, and storing the transmitted data in the data storage.

14. The storage medium according to claim 13, wherein the program further configured to
in the transmitting and receiving data, perform wireless communication mutually with the transmission-direction-side wireless communication terminal within the range of the short-range wireless communication, and transmits data not stored in the transmission-direction-side wireless communication terminal among the data stored in the data storage of the own terminal, to the transmission-direction-side wireless communication terminal.

15. The storage medium according to claim 13, for causing the control device further configured to
when receiving, from the another wireless communication terminal within the range of the short-range wireless communication, propagation information sent and propagated from a specific wireless communication terminal, specify the another wireless communication terminal as being the transmission-direction-side wireless communication terminal located adjacent on a data transmission-direction side of the own terminal on the path, and stores the transmission-direction-side terminal specifying information that is information specifying the transmission-direction-side wireless communication terminal, in the terminal specifying information storage.

16. An information processing method for a wireless communication terminal including a short-range wireless communication unit that performs short-range wireless communication mutually with another wireless communication terminal within a range of short-range wireless communication, and a data storage that stores data, the method comprising:
storing transmission-direction-side terminal specifying information that is information specifying a transmission-direction-side wireless communication terminal being a wireless communication terminal located adjacent to an own terminal in a data transmission direction on a path established to transmit data from the own terminal via another wireless communication terminal by means of the short-range wireless communication,
transmitting and receiving the data stored in the data storage unit to and from the another wireless communication terminal by means of the short-range wireless communication, and
transmitting the data stored in the data storage of the own terminal by means of the short-range wireless communication to only the transmission-direction-side wireless communication terminal specified in the transmission-direction-side terminal specifying information among other wireless communication terminals within the range of the short-range wireless communication.

17. The information processing method according to claim 16, further comprising
performing wireless communication mutually with the transmission-direction-side wireless communication terminal within the range of the short-range wireless communication, and transmits data not stored in the transmission-direction-side wireless communication terminal among data stored in the data storage of the own terminal, to the transmission-direction-side wireless communication terminal.

18. The information processing method according to claim 16, further comprising
when receiving, from the another wireless communication terminal within the range of the short-range wireless communication, propagation information sent and propagated from a specific wireless communication terminal, specifying the another wireless communication terminal as being the transmission-direction-side wireless communication terminal located adjacent on a data transmission-direction side of the own terminal on the path, and stores the transmission-direction-side terminal specifying information that is information specifying the transmission-direction-side wireless communication terminal, in the terminal specifying information storage.
